(19) United States
(12) Patent Application Publication
(10) Pub. No.: US 2019/0295005 A1
(43) Pub. Date: Sep. 26, 2019

(54) Social Booking Platform For One Way Vehicle Rental System

(71) Applicant: MirrorTrip Inc., Vancouver (CA)

(72) Inventors: Reece Griffin, Vancouver (CA); Cameron Lang, Vancouver (CA); Kim Wang, Nanaimo (CA)

(21) Appl. No.: 16/333,984

(22) PCT Filed: Sep. 21, 2017
(86) PCT No.: PCT/US17/52827

§ 371 Date: Mar. 15, 2019

Related U.S. Application Data
(60) Provisional application No. 62/399,247, filed on Sep. 23, 2016.

(51) Int. Cl. G06Q 10/02; G06Q 30/06; G06Q 50/30

(52) U.S. Cl. CPC G06Q 10/02; G06Q 50/30; G06Q 30/0605

(57) ABSTRACT

Disclosed are methods of providing a social booking platform for one way vehicle rental system comprising: receiving a first user's itinerary search parameters; generating and sending a search results list; requesting and receiving a first user's preferred itinerary request; sending the first user's preferred itinerary request to a selected user; requesting and receiving a selected user's acceptance of the first user's preferred itinerary request; sending selected user's acceptance to the first user; requesting and receiving a first user's confirmation and a selected user's confirmation; requesting and receiving a first user's payment; requesting and receiving a selected user's payment; transmitting a payment to a vehicle rental company; receiving confirmations that the first user picked up a vehicle at a first location and dropped off the vehicle at a second location, and the selected user picked up the vehicle at the second location and dropped off the vehicle at the first location.

### CROSS-REFERENCE TO RELATED APPLICATIONS

The present application claims priority to provisional U.S. patent application Ser. No. 62/399,247, filed Sep. 23, 2016 and entitled “Social Booking Platform For One Way Vehicle Rental System,” the disclosure of which is incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates generally to the fields of travel rentals and more specifically relates to one-way vehicle rentals which may be referred to as the “1Way” system.

Carsharing, car sharing, or car clubs is a model of car rental where people rent cars for short periods of time, often by the hour. Car rentals are attractive to users who make only occasional use of a vehicle, as well as users who would like occasional access to a vehicle of a different type than they use day-to-day. A car rental, hire car, or car hire agency is a company that rents automobiles for short periods of time, generally ranging from a few hours to a few weeks. The car rental process is often organized with numerous local branches (which allow a user to return a vehicle to a different location), and primarily located near airports or busy city areas and often complemented by a website allowing online reservations.

However, such a one way rental system often provides logistical problems for rental companies as some locations may encounter a surplus of vehicles, where other locations may have a shortage of available vehicles to manage their rental fleet, vehicle rental fleet rental companies often charge as much as 300% of the total vehicle rental amount to cover the costs brought about by shortages and surpluses at their rental locations. This charge is passed directly onto renters. A suitable solution is desired. Thus, a need exists for a reliable one-way vehicle rental booking platform, and to avoid the above-mentioned problems.

1Way can be considered a social booking network that aims to significantly reduce the costs of vehicle rental for users who wish to drop the vehicle off in a different location to where they picked the vehicle up. It does this by putting users in contact with others who are planning to travel in the reverse direction, such that the second driver returns the vehicle to its original pick up location & the vehicle rental company bills the vehicle at a typical rate as opposed to an elevated rate that is often charged for asymmetric vehicle rentals. The service offers assurances to both drivers by acting as a financial intermediary such that neither driver is ever responsible for the finances of the other driver, as well as by providing customized insurance coverage for this specific type of travel arrangement.

### BRIEF SUMMARY OF THE INVENTION

The present invention advantageously fills the aforementioned deficiencies by providing a social booking platform that virtually (i.e., remotely) connects two drivers, or self-driving vehicles requested by a driver or drivers, which desire to make a one-way trip in opposite directions.

The present invention is superior to other systems in that it effectively saves users time in providing a searchable database accessed by an application that assists in finding a coordinating user that wishes to travel in the opposite direction. By matching users based on specific travel routes, dates, and times, 1Way may potentially save money by utilizing one-way trips specified by the booking users, traveling separately, in opposite directions. To provide financial security to travelers, 1Way acts as a financial intermediary, such that neither driver has to perform financial transactions on behalf of the other.

The present invention integrates with other rental car company booking systems & uses this assimilation to allow all users to collaborate and search for a company or individual that matches their needs, as well as to perform the final booking.

Additionally, it is to be noted, a user or a driver, as mentioned throughout the present invention, can be categorized as either a physical human body operator, or an autonomous vehicle, otherwise known as a self-driving car. References to car may comprise any suitable vehicle.

An embodiment of the present invention is a computer system comprising: at least one processor unit; at least one memory unit coupled to the at least one processor unit; and, computer readable instructions embodied in the memory unit and executable by the processor unit, wherein execution of the instructions by the processor unit causes the computing system to perform a method of providing a social booking platform for one way vehicle rental system. The method comprising: receiving a first user's itinerary search parameters; generating a search results list by matching the first user's itinerary to other users' itineraries; sending the search results list to the first user; requesting a first user's preferred itinerary request; receiving the first user's preferred itinerary request; sending the first user's preferred itinerary request to a selected user; requesting a selected user's acceptance of the first user's preferred itinerary request; receiving the selected user's acceptance; sending selected user's acceptance to the first user; requesting a first user's confirmation; receiving the first user's confirmation; requesting a selected user's confirmation; receiving the selected user's confirmation; requesting a first user's payment; receiving the first user's payment; requesting a selected user's payment; receiving the selected user's payment; transmitting a payment to a vehicle rental company; receiving a confirmation that the first user picked up a vehicle at a first location; receiving a confirmation that the first user dropped off the vehicle at a second location; receiving a confirmation that the selected user picked up the vehicle at the second location; and, receiving a confirmation that the selected user dropped off the vehicle at the first location.

Another embodiment of the present invention is a method of providing a social booking platform for one way vehicle rental system, the method comprising: receiving a first user's itinerary search parameters; generating a search results list by matching the first user's itinerary to other users' itineraries; sending the search results list to the first user; requesting a first user's preferred itinerary request; receiving the first user's preferred itinerary request; sending the first user's preferred itinerary request to a selected user; requesting a selected user's acceptance of the first user's preferred itinerary request; receiving the selected user's acceptance; sending selected user's acceptance to the first user; requesting a first user's confirmation; receiving the first user's confirmation; requesting a selected user's confirmation; receiving the selected user's confirmation; requesting a first user's payment; receiving the first user's payment; requesting a selected user's payment; receiving the selected user's payment; transmitting a payment to a vehicle rental company; receiving a confirmation that the first user picked up a vehicle at a first location; receiving a confirmation that the first user dropped off the vehicle at a second location; receiving a confirmation that the selected user picked up the vehicle at the second location; and, receiving a confirmation that the selected user dropped off the vehicle at the first location.

Yet another embodiment of the present invention is a non-transitory computer readable medium having computer readable instructions embodied therein, the computer readable instructions being configured to implement a method of providing a social booking platform for one way vehicle rental system when executed. The method comprising: receiving a first user's itinerary search parameters; generating a search results list by matching the first user's itinerary to other users' itineraries; sending the search results list to the first user; requesting a first user's preferred itinerary request; receiving the first user's preferred itinerary request; sending the first user's preferred itinerary request to a selected user; requesting a selected user's acceptance of the first user's preferred itinerary request; receiving the selected user's acceptance; sending selected user's acceptance to the first user; requesting a first user's confirmation; receiving the first user's confirmation; requesting a selected user's confirmation; receiving the selected user's confirmation; requesting a first user's payment; receiving the first user's payment; requesting a selected user's payment; receiving the selected user's payment; transmitting a payment to a vehicle rental company; receiving a confirmation that the first user picked up a vehicle at a first location; receiving a confirmation that the first user dropped off the vehicle at a second location; receiving a confirmation that the selected user picked up the vehicle at the second location; and, receiving a confirmation that the selected user dropped off the vehicle at the first location.

In another embodiment of the present invention, the method further comprises generating a secondary search results list by matching the first user's itinerary to other users' itineraries that were received after receiving the first user's itinerary; and, sending the secondary search results list to the first user.

In yet another embodiment of the present invention, the method further comprises providing a private social collaboration area for communications between the first user and the selected user.

In another embodiment of the present invention, the method further comprises receiving a review of the selected user from the first user.

In yet another embodiment of the present invention, the method further comprises receiving a review of the first user from the selected user.

### BRIEF DESCRIPTION OF THE SEVERAL VIEWS OF THE DRAWING

The advantages and features of the present invention will be better understood as the following description is read in conjunction with the accompanying drawings, wherein:

FIG. 1 is a swim-lane diagram of an embodiment of the present invention.

FIG. 2 illustrates a process of providing a social booking platform for one way vehicle rental system.

FIG. 3 illustrates a computerized system of a social booking platform for one way vehicle rental system.

FIG. 4 is an example of a computing environment that can be utilized by embodiments of the present invention.

FIG. 5 illustrates an example of a computing system that can be configured to perform any of the processes of the present invention described herein.

### DETAILED DESCRIPTION OF THE INVENTION

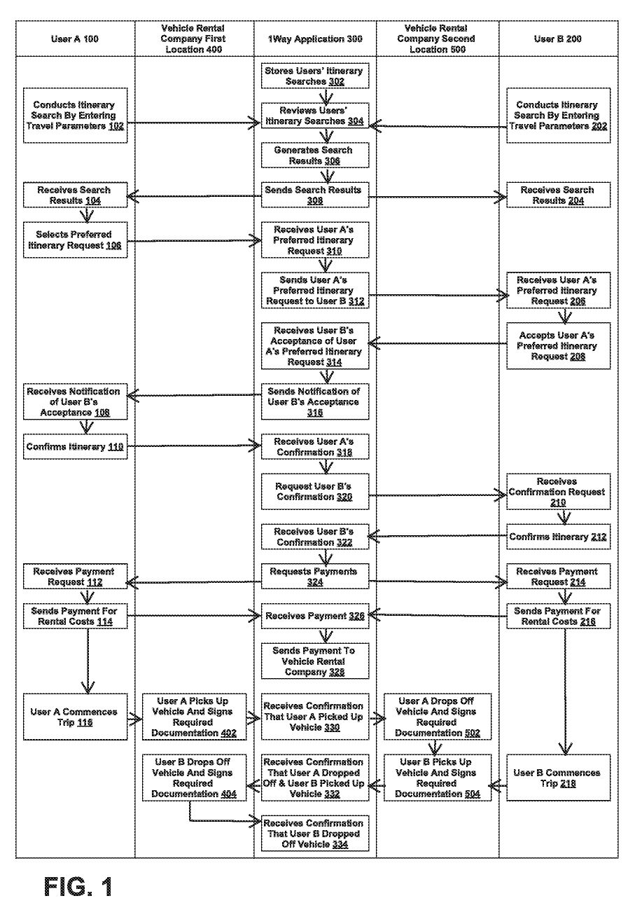

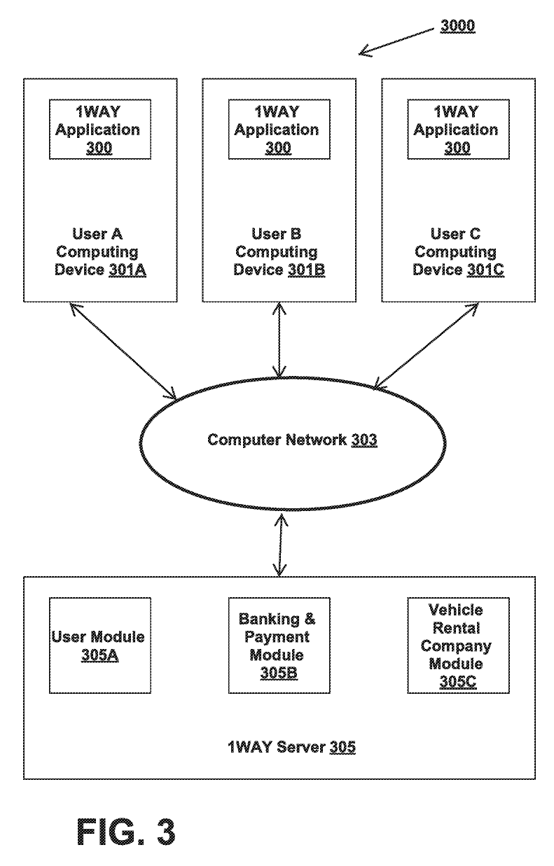

FIGS. 1 and 3 illustrate embodiments of the present invention. User A 100 and User B 200 access the 1Way application 300 with enabled computing device 301A, B, C. The User A 100 conducts itinerary searches by entering travel parameters (102). The parameters include, but are not limited to, desired start date, start location, end date, and end location. The 1Way application 300 the receives User A's 100 itinerary search (304) and compares User A's 100 itinerary search to previous itinerary searches and generates (306) and sends (308) search results to User A 100. User A then receives the search results (104) and selects a preferred itinerary request (106) to User A's liking. User A 100 is not required to select any itinerary from the search list if none meet User A's preferences. In addition, the search results may not generate any itineraries because no itinerary may meet User A's 100 parameters.

If User A 100 selects an itinerary (106), then the 1Way application 300 receives User A's 100 preferred itinerary request (310) and sends the request to User B 200 (312), as User B's 200 itinerary is the one that User A 100 selected as the preferred itinerary. User B 200 receives User As 100 request (206) and may accept the request (208). User B 200 is not required to accept the request. If User B 200 accepts the request (208), then the 1Way application 300 receives User B's 200 acceptance (314). The 1Way application 300 sends a notification of User B's 200 acceptance to User A 100 (316).

Once User A 100 receives User B's 200 acceptance (108), User A 100 may then confirm the itinerary (110). When the 1Way application 300 receives User A's 100 confirmation (318), the 1Way application 300 then requests User B's 200 confirmation (320).

Once User B 200 receives the confirmation request (210), User B 200 may then confirm the itinerary (212). When the 1Way application 300 receives User B's 200 confirmation (322), the 1Way application 300 then requests payment from User A 100 and User B (324).

When User A 100 and User B 200 receive the payment requests (112, 214), they may then submit payment for the rental costs of the vehicle (114, 116). Once payment is received (326), the 1Way application 300 sends the payment to the vehicle rental company (328).

Thereafter, User A 100 may commence her trip (116) by picking up the vehicle and signing the required documentation (402) at the first vehicle rental company location 400. User A 100 will then confirm her commencement of the rental of the vehicle via the 1Way application 300 (330). When User A 100 reaches her destination, the second vehicle rental company location 500, she then drops off the vehicle and signs the required documentation (502). At this time, User A 100 meets User B 200 at the second vehicle rental company location 500. As User B 200 commences his trip (218), he picks up the vehicle and signs the required documentation (504). User A 100 will then confirm that she dropped off the vehicle and User B 200 will then confirm his commencement of the rental of the vehicle via the 1Way application 300 (332). When User B 200 reaches his destination, the first vehicle rental company location 400, he then drops off the vehicle and signs the required documentation (404). Then User B 200 will confirm that he dropped off the vehicle (334).

The enabled computing devices 304, 305, 306 may include such devices as tablet computers, smart phones, personal computers, laptop computers, scanners, game consoles and the like. The 1Way application 300 may be software designed to help users find complimentary itineraries to all the users to save money when renting a vehicle for one way travel. The 1Way application 300 may also communicate with the 1Way server 305 through the computer network 303. The computer network 303 may be, for example, the internet.

The 1Way server 305 may contain various modules, including user module 305A, the banking and payment module 305B, and the vehicle rental company module 305C. Each module 305A, 305A, 305C may store data. For example, the user module 305A may store the user's 100, 200 background information (name, location, account number, login name, passwords, desired start date, start location, end date, end location, among other relevant login and travel information), and other information. The banking and payment module 305B may store information and details of the user's 100, 200 payment information (name, account number, among other information), and other information. Also, the vehicle rental company module 309 may store information related to different vehicle rental companies (name, location, types of vehicles, availability, rates, payment methods, among other booking information), and other information. The 1Way server 305 may contain various other modules not shown, such as, a module that allows the users 100, 200 to write and post reviews and photos related their experiences with other users.

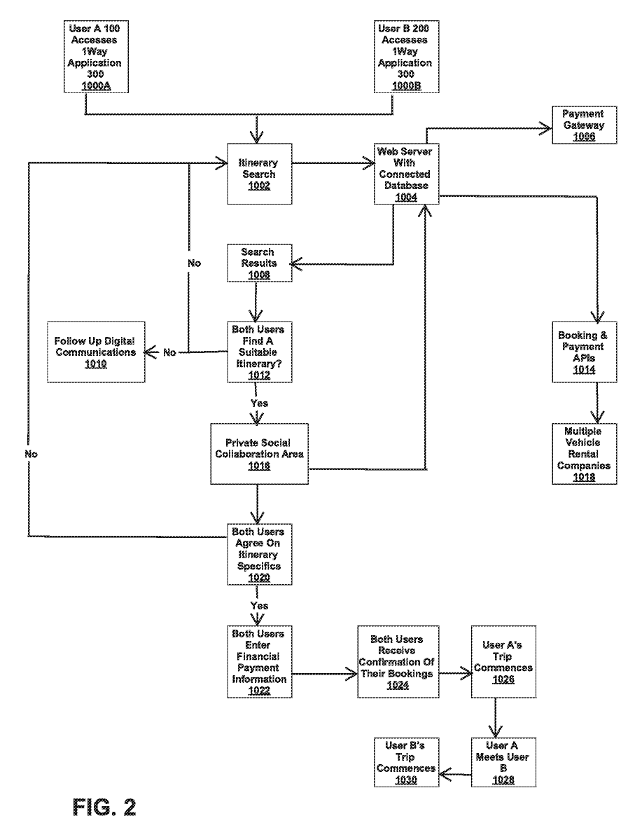

FIG. 2 illustrates another embodiment of the present invention. User A 100 may wish to book a one-way vehicle rental. User B 200 may wish to also book a one-way vehicle rental. User B 200 may wish to travel in the opposite direction to User A 100, such that if User A 100 wants to travel from a first vehicle rental company location 400 to a second vehicle rental company location 500, then User B 200 wants to travel from the second vehicle rental company location 500 to the first vehicle rental company location 400 during a similar time period as User A 100.

User A 100 and User B 200 access the 1Way application 300 (1000A, 1000B) and conduct an itinerary search (1002). The users 100, 200 independently and without need for prior contact with each other enter in the details for the travel itinerary that they would like to execute into the 1Way application 300. The 1Way application 300 contains a database of previous itinerary searches and uses the database to display search results (1008). Each user may either enter their desired start date, start location, end date, and end location if they have a specific trip in mind. Alternatively, if they don't have a specific trip in mind, the users 100, 200 may use a visual discovery interface of the 1Way application 300 to find available trips that might be appealing to them.

The displayed search results (1008) may be a list of zero or more complimentary itineraries that other users have searched for. An itinerary from the search results is considered complimentary if it has opposite start and destination locations compared to the ones entered by the users 100, 200, as well a start date that is the same as the user's 100, 200 end date. The 1Way application 300 may use algorithms to increase the number of search results by also displaying searches that have similar location compliments within a wider geographic radius than originally specified, or similar time compliments with start and end dates within several days of those dates provided by either user 100, 200. The user 100, 200 will be able to filter and sort search results by different points of relevance such as best matching dates, best mating locations, and highest rating of users.

The 1Way application 300 may be connected to a database via a web server (1004), where one or more interconnected servers running web server and database software are capable of executing software routines that allow the servers to execute the business logic required to provide the user experience as depicted FIG. 2.

The 1Way application 300 may also have a payment gateway (1006), which may be a digital system that enables the 1Way application 300 software routines to accept digital payments on behalf of users 100, 200 such that the 1Way application 300 may serve as a financial intermediary to its users 100, 200 and to make direct payment to vehicle rental companies on the behalf of the users 100, 200.

The 1Way application 300 may also have booking and payment APIs (1014), which are one or more digital communication systems that allows the 1Way application 300 to search for available booking rates at one or more vehicle rental companies that match the search criteria of User A 100 or User B 200. The APIs may also allow the 1Way application 300 to make payment directly to a rental company on behalf of User A 100 and User B 200. The APIs may also provide a seamless experience to 1Way application users 100, 200 by allowing them to perform searches, book, and make payment without having to leave the 1Way application 300. The 1Way application 300 may have one or more vehicle rental companies capable of accepting bookings for vehicle rentals and payments for rentals via connected booking and payments APIs (1018).

If both users 100, 200 do not find a suitable itinerary (1012), then the users 100, 200 are provided with an option of having follow up digital communications (1010). This option increases the likelihood of User A 100 or User B 200 finding a matching itinerary. Either user 100, 200 may opt to receive digital communications to notify them at a date prior to their intended departure of any other users who have searched for complimentary travel itineraries since they entered theirs. The 1Way application 300 may generate a secondary search results list by matching the user's 100, 200 itinerary to other users' itineraries that were received after receiving the user's 100, 200 itinerary; and, sending the secondary search results list to the user 100, 200. Alternatively, the users 100, 200 may conduct another itinerary search (1002) with different parameters.

If both users 100, 200 find a suitable itinerary (1012), then may optionally enter the private social collaboration area (1016). If User A 100 and User B 200 consent to collaborate on a booking together, then the 1Way application 300 provides them with a private digital user interface that can only be accessed by the two of them. The collaboration area includes a digital messaging system that allows both users 100, 200 to send and view messages to and from one another, as well as search tools to search for available deals from interconnected vehicle rental companies having specified search criteria including specific travel dates, the type of vehicle required (for example, SUV, compact, economy, truck, motorbike), the vehicle rental company to use, as well as accessories such as GPS, child car seat, among other accessories. The 1Way application 300 may provide customized insurance packages that accommodate this style of travel covering, for example, (a) personal injury, indemnity, collision damage loss/theft, and (b) trip guarantee insurance that allows one user to guarantee their trip in the case that the other user fails to arrive at their destination (for example, in the case User A 100 falls sick, or gets into an accident that might otherwise prevent User B 200 from commencing his trip; User B 200 may insure against this to guarantee his trip). The coverage may include covering the entire cost of a new vehicle rental agreement, or covering the fees of a vehicle relocation company to move the vehicle on behalf of the defunct user.

Thereafter, if both users do not agree on the itinerary specifics (1020), then the users 100, 200 may conduct another itinerary search (1002) with different parameters. On the other hand, If after having collaborated together on the specific details of a trip and both users 100, 200 agree to proceed with the planned itinerary, then they will both be able to provide digital payment information to the 1Way application 300 (1022), which may then collect funds from both users 100, 200 and use the funds to complete a booking with the specific rental company chosen by both users 100, 200. The users 100, 200 both agree to terms and conditions that contractually oblige them to execute their planned itinerary. Each user 100, 200 is charged an amount that is proportionate to the number of days that they plan to use the vehicle compared to the total number of days that the vehicle will be rented.

The users 100, 200 will then receive their respective booking confirmations (1024). Then, User A 100 may commence her trip (1026). User A 100 arrives at the first vehicle rental company location 400, where a vehicle is waiting for her reserved under the name of User A 100. User A 100 signs the required documentation to create an agreement with the vehicle rental company, as anyone ordinarily would when renting a vehicle. The 1Way application 300 may provide updates to User B 200 to notify him that User A 100 has commenced her trip, as well as notifications as User A 100 approaches her final destination, second vehicle rental company location 500, to aid with the timing of the meeting (1028).

Both users 100, 200 meet at the meeting place (1028) agreed on during the itinerary collaboration (1016). The location is one that is sanctioned by the vehicle rental company to have a second driver signed onto the vehicle rental agreement. For example, if both users agree to use Avis rental car, and User A 100 picks the vehicle up in Los Angeles, and assuming that Seattle is the agreed upon final destination for User A 100, then both users 100, 200 meet at an agreed upon Avis rental car location in Seattle. User B 200 signs the required documentation with the vehicle rental company to become an authorized driver of the vehicle, as one normally would when having a second driver signed onto a vehicle rental agreement. Once again no money is exchanged between either user 100, 200, or the vehicle rental company. Both users access the 1Way application 300 to digitally consent that they have successfully changed drivers. Either User A 100, User B 200 or both may use the 1Way application 300 at this stage to capture photographs of the cleanliness, or general condition of the vehicle, as well as to provide photographs of the completed vehicle rental agreement. After both users 100, 200 have digitally consented to the change of driver using the 1Way application 300, either user 100, 200 may rate the other user on aspects including, but not limited to, punctuality, cleanliness of vehicle, and communication.

Then, User B 200 commences and completes his trip (1030). User B 200 drops the rental vehicle off at the agreed upon final destination, in this example, Los Angeles, as one normally would when dropping off a rental vehicle.

Another embodiment of the present invention is a non-transitory computer readable medium having computer readable instructions embodied therein, the computer readable instructions being configured to implement a method of providing a social booking platform for one way vehicle rental system when executed. “Non-transitory computer readable medium” may not include a transitory signal.

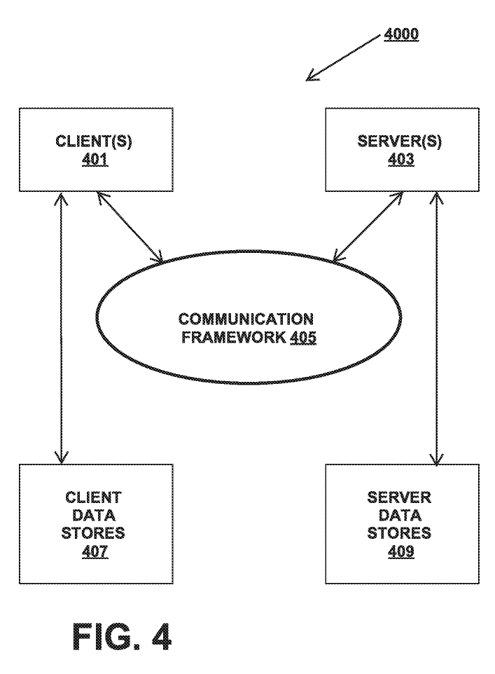

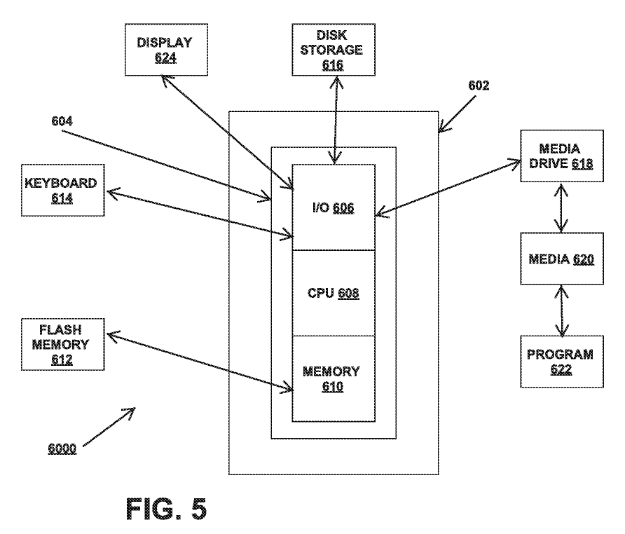

FIGS. 4 and 5 illustrate exemplary computing environments, devices and architectures for the implementation of the various embodiments of the present invention.

FIG. 4 illustrates a sample computing environment 4000 that can be utilized in some embodiments. The system 4000 further illustrates a system that includes one or more client(s) 401. The client(s) 401 can be hardware and/or software (for example, threads, processes, computing devices). The system 4000 also includes one or more server(s) 403, such as 1Way server 305. The server(s) 403 can also be hardware and/or software (for example, threads, processes, computing devices). One possible communication between a client 401 and a server 403 may be in the form of a data packet adapted to be transmitted between two or more computer processes. The system 4000 includes a communication framework 405 that can be utilized to facilitate communications between the client(s) 401 and the server(s) 403. The client(s) 401 are connected to one or more client data store(s) 407 that can be employed to store information local to the client(s) 401. Similarly, the server(s) 403 are connected to one or more server data store(s) 409 that can be employed to store information local to the server(s) 403.

FIG. 5 depicts an exemplary computing system 6000 that can be configured to perform any one of the above-described processes. In this context, computing system 6000 may include, for example, a processor, memory, storage, and I/O devices (for example, monitor, keyboard, disk drive, Internet connection, etc.). However, computing system 6000 may include circuitry or other specialized hardware for carrying out some or all aspects of the processes. In some operational settings, computing system 6000 may be configured as a system that includes one or more units, each of which is configured to carry out some aspects of the processes either in software, hardware, or some combination thereof.

FIG. 5 depicts computing system 6000 with a number of components that may be used to perform the above-described processes. The main system 602 includes a motherboard 604 having an I/O section 606, one or more central processing units (CPU) 608, and a memory section 610, which may have a flash memory card 612 related to it. The I/O section 606 is connected to a display 624, a keyboard 614, a disk storage unit 616, and a media drive unit 618. The media drive unit 618 can read/write a computer-readable medium 620, which can contain programs 622 and/or data. Although, not shown, in some embodiments, computing system 6000 can include an eye-tracking system and/or be coupled with an eye-tracking system.

We claim:

1. A computer system comprising:
at least one processor unit;
at least one memory unit coupled to the at least one processor unit; and,
computer readable instructions embodied in the memory unit and executable by the processor unit, wherein execution of the instructions by the processor unit causes the computing system to perform a method of providing a social booking platform for one way vehicle rental system, the method comprising:
receiving a first user's itinerary search parameters;
generating a search results list by matching the first user's itinerary to other users' itineraries;
sending the search results list to the first user;
requesting a first user's preferred itinerary request;
receiving the first user's preferred itinerary request;
sending the first user's preferred itinerary request to a selected user;
requesting a selected user's acceptance of the first user's preferred itinerary request;
receiving the selected user's acceptance;
sending selected user's acceptance to the first user;
requesting a first user's confirmation;
receiving the first user's confirmation;
requesting a selected user's confirmation;
receiving the selected user's confirmation;
requesting a first user's payment;
receiving the first user's payment;
requesting a selected user's payment;
receiving the selected user's payment;
transmitting a payment to a vehicle rental company;
receiving a confirmation that the first user picked up a vehicle at a first location;
receiving a confirmation that the first user dropped off the vehicle at a second location;
receiving a confirmation that the selected user picked up the vehicle at the second location; and,
receiving a confirmation that the selected user dropped off the vehicle at the first location.

2. The computer system of claim 1, wherein the method further comprises:
generating a secondary search results list by matching the first user's itinerary to other users' itineraries that were received after receiving the first user's itinerary; and,
sending the secondary search results list to the first user.

3. The computer system of claim 1, wherein the method further comprises:
providing a private social collaboration area for communications between the first user and the selected user.

4. The computer system of claim 1, wherein the method further comprises:
receiving a review of the selected user from the first user.

5. The computer system of claim 1, wherein the method further comprises:
receiving a review of the first user from the selected user.

6. A method of providing a social booking platform for one way vehicle rental system, the method comprising:
receiving a first user's itinerary search parameters;
generating a search results list by matching the first user's itinerary to other users' itineraries;
sending the search results list to the first user;
requesting a first user's preferred itinerary request;
receiving the first user's preferred itinerary request;
sending the first user's preferred itinerary request to a selected user;
requesting a selected user's acceptance of the first user's preferred itinerary request;
receiving the selected user's acceptance;
sending selected user's acceptance to the first user;
requesting a first user's confirmation;
receiving the first user's confirmation;
requesting a selected user's confirmation;
receiving the selected user's confirmation;
requesting a first user's payment;
receiving the first user's payment;
requesting a selected user's payment;
receiving the selected user's payment;
transmitting a payment to a vehicle rental company;
receiving a confirmation that the first user picked up a vehicle at a first location;
receiving a confirmation that the first user dropped off the vehicle at a second location;
receiving a confirmation that the selected user picked up the vehicle at the second location; and,
receiving a confirmation that he selected user dropped off the vehicle at the first location.

7. The method of claim 6 further comprising:
generating a secondary search results list by matching the first user's itinerary to other users' itineraries that were received after receiving the first user's itinerary; and,
sending the secondary search results list to the first user.

8. The method of claim 6 further comprising:
providing a private social collaboration area for communications between the first user and the selected user.

9. The method of claim 6 further comprising:
receiving a review of the selected user from the first user.

10. The method of claim 6 further comprising:
receiving a review of the first user from the selected user.

11. A non-transitory computer readable medium having computer readable instructions embodied therein, the computer readable instructions being configured to implement a method of providing a social booking platform for one way vehicle rental system when executed, the method comprising:
receiving a first user's itinerary search parameters;
generating a search results list by matching the first user's itinerary to other users' itineraries;
sending the search results list to the first user;
requesting a first user's preferred itinerary request;
receiving the first user's preferred itinerary request;
sending the first user's preferred itinerary request to a selected user;
requesting a selected user's acceptance of the first user's preferred itinerary request;
receiving the selected user's acceptance;
sending selected user's acceptance to the first user;
requesting a first user's confirmation;
receiving the first user's confirmation;
requesting a selected user's confirmation;
receiving the selected user's confirmation;
requesting a first user's payment;
receiving the first user's payment;
requesting a selected user's payment;
receiving the selected user's payment;
transmitting a payment to a vehicle rental company;
receiving a confirmation that the first user picked up a vehicle at a first location;
receiving a confirmation that the first user dropped off the vehicle at a second location;
receiving a confirmation that the selected user picked up the vehicle at the second location; and,
receiving a confirmation that the selected user dropped off the vehicle at the first location.

12. The non-transitory computer readable medium of claim 11, wherein the method further comprises;
generating a secondary search results list by matching the first user's itinerary to other users' itineraries that were received after receiving the first user's itinerary; and,
sending the secondary search results list to the first user.

13. The non-transitory computer readable medium of claim 11, wherein the method further comprises;
providing a private social collaboration area for communications between the first user and the selected user.

14. The non-transitory computer readable medium of claim 11, wherein the method further comprises:
receiving a review of the selected user from the first user.

15. The non-transitory computer readable medium of claim 11, wherein the method further comprises:
receiving a review of the first user from the selected user.
